(19) United States
(12) Patent Application Publication
(10) Pub. No.: US 2026/0285111 A1
(43) Pub. Date: Sep. 24, 2026

(54) METHOD FOR A CONTROLLED CHASSIS FOR HANDLING CRESTS AND DIPS

(71) Applicant: AUDI AG, Ingolstadt (DE)

(72) Inventor: Andreas UNGER, Gaimersheim (DE)

(73) Assignee: AUDI AG, Ingolstadt (DE)

(21) Appl. No.: 19/444,371

(22) Filed: Jan. 9, 2026

(30) Foreign Application Priority Data
Mar. 21, 2025 (DE) 102025111056.5

(51) Int. Cl. B60G 17/016

(52) U.S. Cl. CPC B60G 17/0164; B60G 2400/204

(57) ABSTRACT

A chassis control system for an active chassis, including a first operating state, the chassis control system in the first operating state is configured to use an absolute speed of a vehicle body to control a movement of the vehicle body; a second operating state, the chassis control system in the second operating state is configured to use a relative speed of the vehicle body between the vehicle body and a wheel to dampen the movement of the vehicle body at that wheel; and a third operating state, the third operating state has a blend factor α. The chassis control system is configured in the third operating state to assume the first operating state in a proportion of 1−α, where α is in the range 0 to 1, and the second operating state in a proportion of α; depending on the absolute speed of the vehicle body.

### FIELD

The present invention relates to a chassis control system for an active chassis, a method for operating the chassis control system, and a vehicle having a chassis control system.

### BACKGROUND

Active chassis typically use actuators, which are usually positioned between the vehicle body and the wheels, in particular to generate active forces. The Skyhook algorithm is usually used to control the vehicle body movement, which calculates a target force which usually depends on the absolute vehicle body speed by a factor. The vehicle body speed cannot be measured directly, wherein high-pass filters are usually used to determine the vehicle body speed. Depending on the track, this can lead to undesirable effects.

### SUMMARY

It is therefore an object of the present invention to improve and/or simplify a chassis, in particular its control, preferably to reduce one or more of the above-mentioned disadvantages, preferably to avoid them.

This object is achieved according to the teaching of independent claims. Various embodiments and further developments of the invention are the subject of the dependent claims.

According to an embodiment of the present invention, a chassis control system is provided for an active chassis. In one embodiment, the chassis control system has a first operating state. In one embodiment, the chassis control system is designed to use an absolute speed of a vehicle body to control the movement of the vehicle body in the first operating state.

In one embodiment, the chassis control system has a second operating state. In one embodiment, the chassis control system is designed to use, in the second operating state, a relative speed of the vehicle body between the vehicle body and one wheel for damping the movement of the vehicle body at this wheel. In one embodiment, the chassis control system has a third operating state. In one embodiment, the chassis control system is configured to assume the first operating state in the proportion of 1-α in the third operating state, where α is in the range 0 to 1, and to assume the second operating state in a proportion of α; depending on the absolute speed of the vehicle body.

The term “absolute speed of a vehicle body”, as used herein, is to be understood in particular as a speed of the vehicle body which is, at least substantially, parallel to a normal on a ground surface. In one embodiment, the absolute speed of the vehicle body is determined by integrating the acceleration of the vehicle body, in particular its absolute acceleration. In one embodiment, the signal to be integrated, in particular an acceleration measurement, is high-pass filtered.

Advantageously, in one embodiment, this makes it possible to retain, at least substantially, the cutoff frequency of the high-pass filter for filtering the signal to be integrated, in particular at a low value, such as, but not limited to, less than 0.5 Hz, or less than 0.3 Hz, or (less than) 0.1 Hz. A change in terrain can be implemented more easily with the chassis control system described herein, in certain embodiments, in particular, in one embodiment, it is possible to forego increasing the cutoff frequency, in particular to 0.8 Hz or more, in order to be able to compensate for any crests and/or dips that may occur, in particular in a way that is or can be interpreted as comfortable by a vehicle occupant. Advantageously, this (still) allows, in one embodiment, for driving behavior to be safe or safer, in particular when, temporarily, in particular for short periods of time, such as seconds or less, a chassis control system, at least partially, is operated or can be operated in the second operating state, in particular using the third operating state, and furthermore, a chassis control system or damping system is determined or can be determined based on or using a relative speed of the vehicle body, or is or can be used for damping, in particular of crests and/or dips.

In one embodiment, the blend factor α has a linear relationship with the absolute speed of the vehicle body, in particular section by section over the absolute speed of the vehicle body.

The “blend factor α”, as described herein, is described—without loss of generality—in a range from 0 to 1. As is clear to those skilled in the art, other ranges can also be used, in particular in percent or the like and/or with, in particular, predetermined absolute values, in particular such that, depending on the absolute speed of the vehicle body, it is or it may be possible to switch back and forth between a first operating state and a second operating state, in particular in a third operating state.

Advantageously, this allows, in one embodiment, for a simple or simpler transition between a first operating state and a second operating state, in particular in a third operating state, furthermore in particular depending on a requirement for the chassis or depending on the nature of the terrain or track to be driven on.

In one embodiment, the blend factor α exhibits a linear, logarithmic, exponential and/or S-curve-like profile over the absolute speed of the vehicle body, in particular in sections. In one embodiment, the blend factor α exhibits combination of a linear, logarithmic, exponential and/or S-curve-like profile over the absolute speed of the vehicle body.

Advantageously, this allows, in one embodiment, the chassis control system to be adapted to a requirement of the vehicle, the vehicle type and/or the requirements of the driver and/or the vehicle occupants, in particular this can increase the safety of the vehicle or the feeling of safety.

In one embodiment, the chassis control system is configured to use a Skyhook algorithm in the first operating state.

Advantageously, in one embodiment, this makes it possible to traverse a section of track with terrain, in particular crests and/or depressions, in which there are larger and, at least substantially, (very) low-frequency elevations with respect to a chassis control system, where forces would typically be requested by the Skyhook algorithm that pull the vehicle body into the, in particular lower, stops of the wheel suspension, using the chassis control system described herein to vary a proportion of the first operating state and the second operating state in a third operating state, in particular depending on the absolute speed of the vehicle body.

In one embodiment, the blend factor α depends on an amount of the absolute speed of the vehicle body and/or is set up such that a cross-fade, in particular from a first operating state to a second operating state or vice versa, begins with the help of the blend factor at a predetermined lower absolute speed of the vehicle body and/or is at its maximum at a predetermined upper absolute speed of the vehicle body. In one embodiment, a predetermined lower absolute speed of the vehicle body is 0.4 m/s or more, or 0.5 m/s or more and/or at most 0.6 m/s, or at most 0.7 m/s. In one embodiment, a predetermined upper absolute speed of the vehicle body is at most 1.1 m/s or at most 1.0 m/s or at most 0.9 m/s; and/or at least 0.8 m/s, or at least 0.7 m/s.

In one embodiment, the absolute speed of the vehicle body is determined by integrating the acceleration of the vehicle body. In one embodiment, the relative speed of the vehicle body is determined by deriving a spring travel between the vehicle body and the wheel. In one embodiment, a sensor is used for this purpose, in particular a spring travel sensor. In one embodiment, the chassis control system has such a sensor. Furthermore, in a further development, the chassis control system features a low-pass filter, which is used or can be used in particular to filter the sensor signal.

Advantageously, this allows, in one embodiment, a reliable or more reliable determination of the relative speed of the vehicle body, in particular the removal of high-frequency components such as signal noise, and furthermore, the disadvantages of a high-pass filter, which is used in particular for the signal to be integrated to determine an absolute speed of the vehicle body, do not play a role, at least in essence, when determining the relative speed.

In one embodiment, the chassis control system is designed so that the third operating state can be switched on and/or off. In one embodiment, the third operating state can be switched on and/or off, in particular by a user of the vehicle.

Advantageously, this allows the user of the vehicle to adjust the comfort of the vehicle driving behavior in one embodiment.

In one embodiment, a target force for the chassis control system in the first operating state can be or is qualitatively determined using the following formula: F_B1=fac_B1 * v_{A_abs} where v_{A_abs} represents the absolute speed of the vehicle body, and the target force F_B1 depends on the absolute speed of the vehicle body by a factor fac_B1. In one embodiment, a target force or target damping for the chassis control system in the second operating state can be qualitatively determined using the following formula: F_B2=fac_B2 * v_{A_rel}, wherein v_{A_rel} represents the relative speed of the vehicle body, and the target force F_B2 depends on the relative speed of the vehicle body by a factor fac_B2. In one embodiment, the target force for the chassis control system in the third operating state can be or is qualitatively determined using the following formula: F_B3=((1−α) * F_B1)+(α * F_B2), where the blend factor α determines a proportion of the operating states over the absolute speed. The blend factor α is determined, in one embodiment, via a predetermined characteristic map and/or as described herein.

Advantageously, this allows, in one embodiment, a chassis control system to adapt or be adaptable (more) easily to crests and/or dips, and is in particular safe(r) when encountering crests and/or dips.

According to one embodiment of the present invention, a method for operating a chassis control system, in particular as described herein, is provided. In one embodiment, the method involves determining an absolute speed of the vehicle body. In one embodiment, the method involves determining an operating state, in particular based on the determined absolute speed of the vehicle body. In one embodiment, the method involves determining a blend factor α in particular based on the determined absolute speed of the vehicle body. In one embodiment, the method involves determining a relative speed of the vehicle body, in particular based on the determined operating state. In one embodiment, the method involves operating the chassis control system, in particular based on the determined operating state.

Advantageously, in one embodiment, this allows a chassis control system to be reactive or to react more easily to different track conditions, in particular by setting a lower cutoff frequency of the high-pass filter for determining the absolute speed of the vehicle body, in particular comparatively lower, and, in other embodiments, by ensuring that the vehicle body is (nevertheless) not strongly deflected on track sections with or at crests and/or dips, and that the vehicle remains (more) safely damped in these sections.

According to one embodiment of the present invention, a vehicle is provided which has a chassis control system as described herein and/or means for determining an absolute speed of the vehicle body, in particular an acceleration sensor, in particular with corresponding data processing; means for determining an operating state of the chassis control system; means for determining a blend factor α; means for determining a relative speed of the vehicle body; and means for operating the chassis control system.

Advantageously, in one embodiment, this allows the vehicle to be driven (more) safely.

A system and/or a means according to the present invention can be designed in terms of hardware and/or software, in particular comprising at least one, preferably data-or signal-connected, in particular digital, processing unit, in particular microprocessor unit (CPU), graphics card (GPU) or the like, and/or one or more programs or program modules with a storage and/or bus system. The processing unit can be configured to execute instructions implemented as a program stored in a memory system, process them to capture input signals from a data bus and/or to output signals to a data bus. A storage system may comprise one or more, in particular different, storage media, in particular optical, magnetic, solid-state and/or other non-volatile media. The program can be designed in such a way that it embodies or is capable of executing the methods described here, so that the processing unit can perform the steps of such methods and thus, in particular, operate or monitor the chassis control system.

A computer program product may, in one embodiment, include a storage medium, in particular a computer-readable and/or non-volatile medium, for storing a program or instructions, or with a program or instructions stored thereon. In one embodiment, the execution of this program or these instructions by a system or a controller, in particular a computer or an arrangement of several computers, causes the system or the controller, in particular the computer(s), to execute a method described herein or one or more of its steps, or the program or instructions are set up for this purpose.

In one embodiment, one or more, in particular all, steps of the method are carried out fully or partially automatically, in particular by the control system or its means.

Any terms used herein, such as “comprises”, “contains”, “includes”, “indicates”, “has”, “with”, or any other variant thereof, are intended to cover non-exclusive inclusion. For example, a method or device that comprises or includes a list of elements is not necessarily limited to those elements, but may include other elements that are not expressly listed or that are inherent in such a method or device.

Furthermore, unless explicitly stated otherwise, “or” refers to an inclusive or and not an exclusive “or”. For example, a condition A or B is satisfied by one of the following conditions: A is true (or present) and B is false (or not present), A is false (or not present) and B is true (or present), and both A and B are true (or present).

The terms “one” or “one”, as used here, are defined in the sense of “one or more”. The terms “another” and “a further” as well as any other variant thereof are to be understood in the sense of “at least one more”.

The terms “configured” or “set up” to perform a specific function (and any variations thereof), as possibly used here, are to be understood as meaning that a device or component thereof is already in a configuration or setting in which it can perform the function, or at least is adjustable—i.e., configurable—so that it can perform the function after appropriate adjustment. The configuration can be achieved, for example, by adjusting parameters of a process flow or by using switches or similar to activate or deactivate functionalities or settings. In particular, the device may have several predetermined configurations or operating modes, so that the configuration can be carried out by selecting one of these configurations or operating modes.

### BRIEF DESCRIPTION OF THE FIGURES

Further advantages, features and possible uses of the invention will be apparent from the following detailed description in conjunction with the figures. In particular

FIG. 1 schematically shows a quarter-vehicle model, as well as a schematically shown terrain with schematically resulting values for an absolute speed of the vehicle body and a relative speed of the vehicle body; and

FIG. 2 schematically shows a blend factor α versus an absolute speed of the vehicle body.

### DETAILED DESCRIPTION

In the figures, identical reference numerals denote identical, similar, or corresponding elements. Elements depicted in the figures are not necessarily shown to scale. Rather, the various elements depicted in the figures are rendered in such a way that their function and general purpose become understandable to the skilled in the art. Connections and couplings between functional units and elements shown in the figures can also be implemented as indirect connections or couplings, unless explicitly stated otherwise. Functional units can be implemented in particular as hardware, software, or a combination of hardware and software.

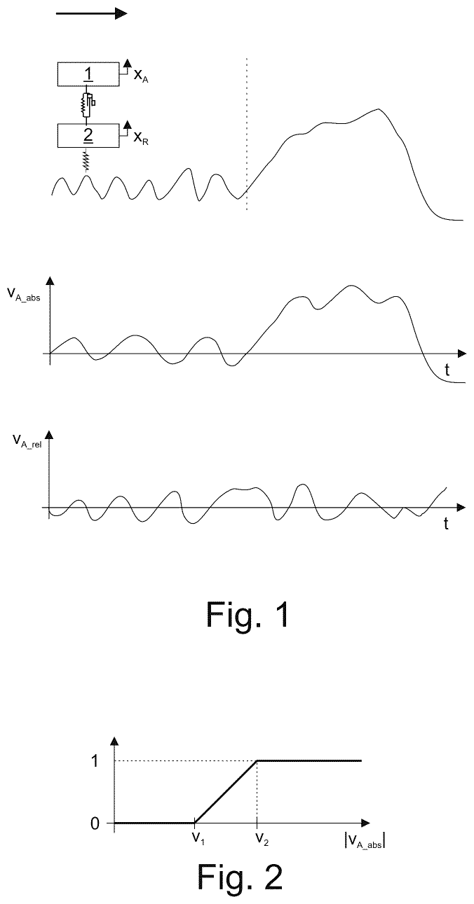

FIG. 1 schematically shows a quarter-vehicle model moving along a track, in particular at a constant speed. The model features a vehicle body 1 and a wheel 2, which are connected to each other in a controllable manner. The direction of movement is indicated in the direction of the arrow, with the track having a first part with unevenness and a second part with a crest (schematically separated by the dashed line).

Furthermore, FIG. 1 schematically shows a curve of the absolute speed of the vehicle body 1, and below it a curve of the relative speed of the vehicle body 1. A relative speed can be determined, as schematically shown in FIG. 1, by deriving the spring travels x_{A} (vehicle body) and x_{R} (wheel).

FIG. 2 schematically shows a characteristic map for a blend factor α versus an absolute speed of the vehicle body. The characteristic map can, as schematically shown, have a predetermined lower absolute speed v₁ and a predetermined upper absolute speed v₂ of the vehicle body. FIG. 2 schematically shows sections of a linear relationship between the blend factor α and (an amount) of the absolute speed of the vehicle body. The blend factor α is varied or determined within a range between 0 and 1. Depending on the blend factor α, the system varies or cross-fades between a first operating state and a second operating state of the chassis control system.

While at least one exemplary embodiment has been described above, it should be noted that a large number of variations exist. It should also be noted that the exemplary embodiments described are only non-limiting examples, and it is not intended to restrict the scope, applicability or configuration of the devices and methods described herein. Rather, the preceding description will provide the person skilled in the art with guidance on the implementation of at least one exemplary embodiment, wherein it is understood that various changes in the functioning and arrangement of the elements described in an exemplary embodiment may be made without deviating from the subject matter defined in the attached claims and its legal equivalents.

1. A chassis control system for an active chassis, comprising: a first operating state, wherein the chassis control system in the first operating state is configured to use an absolute speed of a vehicle body to control movement of the vehicle body;
a second operating state, wherein the chassis control system in the second operating state is configured to use a relative speed of the vehicle body between the vehicle body and a wheel to dampen the movement of the vehicle body at that wheel; and
a third operating state, wherein the third operating state has a blend factor α, wherein the chassis control system is designed in the third operating state to adopt the first operating state proportional to 1−α, wherein α is in the range 0 to 1, and the second operating state proportional to α, depending on the absolute speed of the vehicle body.

2. The chassis control system according to claim 1, wherein the blend factor α has a linear relationship with the absolute speed of the vehicle body.

3. The chassis control system according to claim 1, wherein the blend factor α exhibits a linear, logarithmic, exponential and/or S-curve-like profile over the absolute speed of the vehicle body.

4. The chassis control system according to claim 1, wherein the chassis control system is configured to use a Skyhook algorithm in the first operating state.

5. The chassis control system according to claim 1, wherein the blend factor α depends on an amount of the absolute speed of the vehicle body and/or is set up such that a cross-fade begins with the help of the blend factor at a predetermined lower absolute speed of the vehicle body and/or is at its maximum at a predetermined upper absolute speed of the vehicle body.

6. The chassis control system according to claim 1, wherein the absolute speed of the vehicle body is determined by integrating the acceleration of the vehicle body and/or wherein the relative speed of the vehicle body is determined by deriving a spring travel between the vehicle body and the wheel.

7. A method for operating a chassis control system according to claim 1, comprising:
determining the absolute speed of the vehicle body;
determining an operating state, based on the determined absolute speed of the vehicle body;
determining a blend factor α, based on the determined absolute speed of the vehicle body;
determining a relative speed of the vehicle body based on the determined operating state; and
operating the chassis control system based on the determined operating state.

8. A vehicle comprising a chassis control system according to claim 1 and comprising:
means for determining an absolute speed of the vehicle body;
means for determining an operating state of the chassis control system;
means for determining a blend factor α;
means for determining a relative speed of the vehicle body; and
means for operating the chassis control system.

9. The chassis control system according to claim 2, wherein the chassis control system is configured to use a Skyhook algorithm in the first operating state.

10. The chassis control system according to claim 3, wherein the chassis control system is configured to use a Skyhook algorithm in the first operating state.

11. The chassis control system according to claim 2, wherein the blend factor α depends on an amount of the absolute speed of the vehicle body and/or is set up such that a cross-fade begins with the help of the blend factor at a predetermined lower absolute speed of the vehicle body and/or is at its maximum at a predetermined upper absolute speed of the vehicle body.

12. The chassis control system according to claim 3, wherein the blend factor α depends on an amount of the absolute speed of the vehicle body and/or is set up such that a cross-fade begins with the help of the blend factor at a predetermined lower absolute speed of the vehicle body and/or is at its maximum at a predetermined upper absolute speed of the vehicle body.

13. The chassis control system according to claim 4, wherein the blend factor α depends on an amount of the absolute speed of the vehicle body and/or is set up such that a cross-fade begins with the help of the blend factor at a predetermined lower absolute speed of the vehicle body and/or is at its maximum at a predetermined upper absolute speed of the vehicle body.

14. The chassis control system according to claim 2, wherein the absolute speed of the vehicle body is determined by integrating the acceleration of the vehicle body and/or wherein the relative speed of the vehicle body is determined by deriving a spring travel between the vehicle body and the wheel.

15. The chassis control system according to claim 3, wherein the absolute speed of the vehicle body is determined by integrating the acceleration of the vehicle body and/or wherein the relative speed of the vehicle body is determined by deriving a spring travel between the vehicle body and the wheel.

16. The chassis control system according to claim 4, wherein the absolute speed of the vehicle body is determined by integrating the acceleration of the vehicle body and/or wherein the relative speed of the vehicle body is determined by deriving a spring travel between the vehicle body and the wheel.

17. The chassis control system according to claim 5, wherein the absolute speed of the vehicle body is determined by integrating the acceleration of the vehicle body and/or wherein the relative speed of the vehicle body is determined by deriving a spring travel between the vehicle body and the wheel.
